(19) United States
(12) Patent Application Publication
(10) Pub. No.: US 2010/0266427 A1
(43) Pub. Date: Oct. 21, 2010

(54) GUIDE RING FOR A PISTON PUMP, AND PISTON PUMP

(76) Inventors: Juergen Haecker, Schwieberdingen (DE); Rene Schepp, Waiblingen (DE); Norbert Alaze, Markgroeningen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/741,485

(22) PCT Filed: Sep. 23, 2008
(86) PCT No.: PCT/EP08/62661

§ 371 Date: May 5, 2010

(30) Foreign Application Priority Data
Nov. 5, 2007 (DE) 102007052664.6

(51) Int. Cl. F16C 29/02; F04B 1/053; F04B 53/00

(52) U.S. Cl. 417/273; 384/10

(57) ABSTRACT

The invention relates to a guide ring for an axially reciprocating pump piston, or for a pump rod of a piston pump. The invention provides for the guide ring to be configured as a radial damping element for damping radial impacts of the pump piston or of the pump rod. The invention further relates to a piston pump having such a guide ring.

### PRIOR ART

The invention relates to a guide ring as generically defined by the preamble to claim 1 and to a piston pump as generically defined by the preamble to claim 8.

Piston pumps are used in hydraulic vehicle brake systems of motor vehicles and are often called return pumps. In a traction control operation, they serve to raise or lower the brake pressure in the wheel brake cylinders selectively in order to enable regulating the brake pressure in the wheel brake cylinders.

In known piston pumps, the problem exists that the tightness of the piston pump must be ensured over a wide temperature range, in particular to temperatures around approximately −30° C., in order to prevent an escape of brake fluid from the brake system and/or aspiration of air into the brake system. This problem is described in German Patent Disclosure DE 10 2005 046 048 A1, for example. At low temperatures, because of radial impacts of the pump piston or the piston rod, a crescent-shaped gap, through which brake fluid can escape from the brake system, is created between the pump piston or the piston rod of the piston pump and a ring seal. The formation of the gap can be ascribed to the low flexibility of the ring seal at low temperatures and to high loading speeds of the pump piston or piston rod.

For solving this problem, German Patent Disclosure 10 2005 046 048 A1 proposes using a two-part ring seal, which has an abrasion-resistant outer skin and an inner core of a material that is flexible when cold. A guide ring for guiding the piston and a support ring are disposed axially between the two-part ring seal and an eccentric chamber in the known piston pump, and the support ring prevents the seal from being drawn into the guide gap between the pump piston or pump rod and the guide ring.

### DISCLOSURE OF THE INVENTION

### Technical Object

It is the object of the invention to propose an alternative solution to the problem of avoiding leakage of the piston pump at low temperatures and high load speeds. In particular, leakage should be securely avoided with conventional single-material ring seals as well.

### Technical Solution

This object is attained by the use of a guide ring having the characteristics of claim 1 and with a piston pump having the characteristics of claim 8. Advantageous refinements of the invention are recited in the dependent claims. All combinations of at least two characteristics disclosed in the specification, claims, and/or drawings are within the scope of the invention.

The invention is based on the concept of embodying a guide ring for guiding the piston; the guide ring is penetrated by the pump piston or pump rod in such a way that it damps the radial deflection motions of the pump piston or pump rod that can be ascribed for instance to a radial force component exerted by an eccentric on the pump piston or piston rod. Because the radial impacts of the pump piston or piston rod are damped by the guide ring, in particular in such a way that the speed of the deflection motion is reduced and/or the amplitude of the radial impacts is minimized, a ring seal disposed preferably axially adjacent to the guide ring is capable, even at low temperatures and at a high axial loading speed of the pump piston or piston rod, of following the radial deflection motions, that is, the radial impacts of the pump piston or piston rod. As a result, in turn, a durable contact of the ring seal with the pump piston or piston rod is assured, which in turn prevents the formation of a crescent-shaped gap between the pump piston or piston rod and the ring seal, or at least minimizes the size of a crescent-shaped gap. The embodiment according to the invention of a guide ring has the advantage that even with conventional ring seals, sealing off of the high-pressure region of the pump from a low-pressure region, in particular an eccentric chamber, can be ensured. It is understood that the tightness can be further improved if a ring seal, described in DE 10 2005 046 048 A1, is provided in addition to a guide ring embodied in accordance with the concept of the invention.

An exemplary embodiment of the radially damping guide ring in which the damping is attained by the provision of at least one encompassing, radially elastic lip is especially advantageous. The lip serves as a radially resilient damping means that securely damps the radial deflection motions of the pump piston or piston rod. Instead of the provision of a lip extending over the entire circumference of the guide ring, an embodiment can be attained in which at least two circumferentially spaced-apart lip segments or spring elements, preferably resting on the pump piston, are provided for radially damping deflection motions of the pump piston or piston rod.

An embodiment in which the inner diameter of the at least one lip, in the uninstalled state, is less at least in one region and preferably in a free end region than the outer diameter of the pump piston or piston rod is especially advantageous. As a result, a tight contact of the lip with the pump piston or piston rod is achieved. In such an embodiment, the first lip not only has the function of a damping element but also simultaneously serves as a stripper ring for stripping off dirt particles, which can be carried in particularly from the direction of an eccentric chamber. Thus the lip effectively prevents dirt particles from advancing to the ring seal, and the service life of the ring seal is increased as a result, because of reduced wear. In contrast to known guide rings, by means of the embodiment of the guide ring as closely contacting the pump piston or piston rod, guidance play between the pump piston or piston rod and the guide ring, and at least between the lip of the guide ring and the pump piston, is avoided.

In a refinement of the invention, it is advantageously provided that the guide ring has at least one second, radially resilient lip, which in particular extends all the way around. The two lips that in particular extend all the way around are preferably spaced apart axially from one another, in order to achieve optimal guidance of the pump piston or piston rod and simultaneous damping of radial deflection motions of the pump piston or piston rod. Moreover, such an embodiment of the guide ring offers the advantage that a support ring previously used, which is disposed axially between the ring seal and the guide ring in order to prevent the seal from being drawn into a guide gap between the guide ring and the pump piston or piston rod, can be dispensed with as needed, since the second lip takes on the task of a support ring.

An embodiment in which the two lips are disposed with free end edges, extending all the way around and pointing in opposite axial directions, is especially advantageous, and it is within the scope of this refinement that the end edges are additionally inclined in the direction of the pump piston or in the direction of the piston rod. Particularly in such an embodiment, the drawing in of the ring seal into a region radially between the guide ring and the pump piston or piston rod is advantageously avoided.

Preferably, the second radially resilient lip, preferably extending all the way around, is embodied such that its inner diameter in the uninstalled state is less than the outer diameter of the pump piston or piston rod, in order to ensure close contact of the guide ring or of the second guide lip with the pump piston or piston rod.

An embodiment in which the guide ring is made of a thermoplastic and in particular high-strength thermoplastic material is especially preferred, so that on the one hand the guidance task and on the other the damping action can be securely attained. It is especially preferable if the guide ring is produced as a one-piece injection-molded part from a high-strength thermoplastic material. The thermoplastic material should be selected such that it does not lose its damping action, that is, its radially (slightly) resilient action, even at temperatures around approximately −30° C.

The invention also provides a piston pump that has a guide ring as described above; the guide ring is preferably fixed in a pump bore in a hydraulic block by means of a press fit.

Preferably, the guide ring is disposed axially between an eccentric chamber, in which an eccentric is driven to rotate, and a ring seal. It is especially advantageous if the guide ring is equipped with at least one radially resilient lip, which preferably extends all the way around and which is disposed with its free end edge pointing in the direction of the eccentric chamber. In this embodiment, the first lip has in addition to the damping function a dirt stripping function, which prevents the penetration of dirt particles into a region between the ring seal and the guide ring. This leads to a longer service life of the ring seal.

In a refinement of the invention, it is advantageously provided that the guide ring has at least one second, radially resilient lip, which is disposed with its free end edge pointing in the direction of the ring seal. As a result, a support ring axially between the ring seal and the guide ring may optionally be dispensed with.

### BRIEF DESCRIPTION OF THE DRAWINGS

Further advantages, characteristics and details of the invention will become apparent from the ensuing description of preferred exemplary embodiments as well as in conjunction with the drawings. Shown in the drawings are:

FIG. 1: a perspective view of a guide ring for a piston pump;

FIG. 2: an enlarged longitudinal sectional view of the guide ring of FIG. 1;

FIG. 3: a detail of a piston pump with a guide ring in accordance with FIGS. 1 and 2; and

FIG. 4: an enlarged detail of FIG. 3.

### EMBODIMENTS OF THE INVENTION

In the drawings, identical components and components with the same function are identified by the same reference numerals.

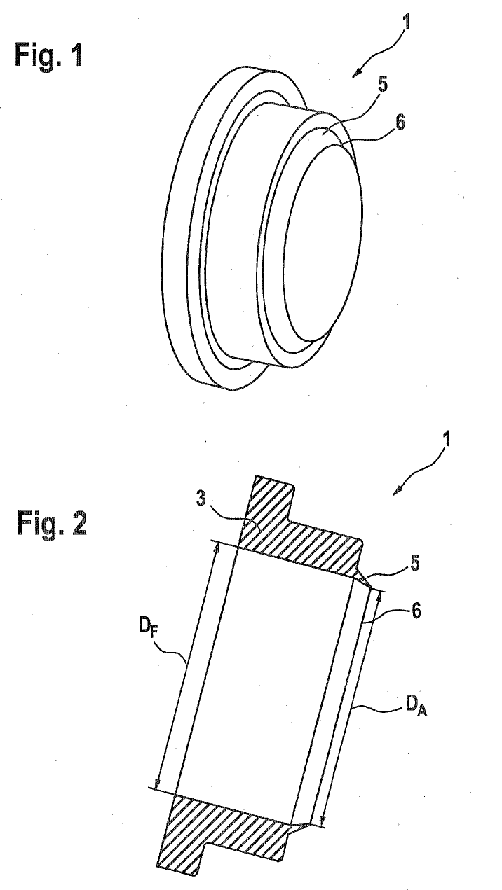

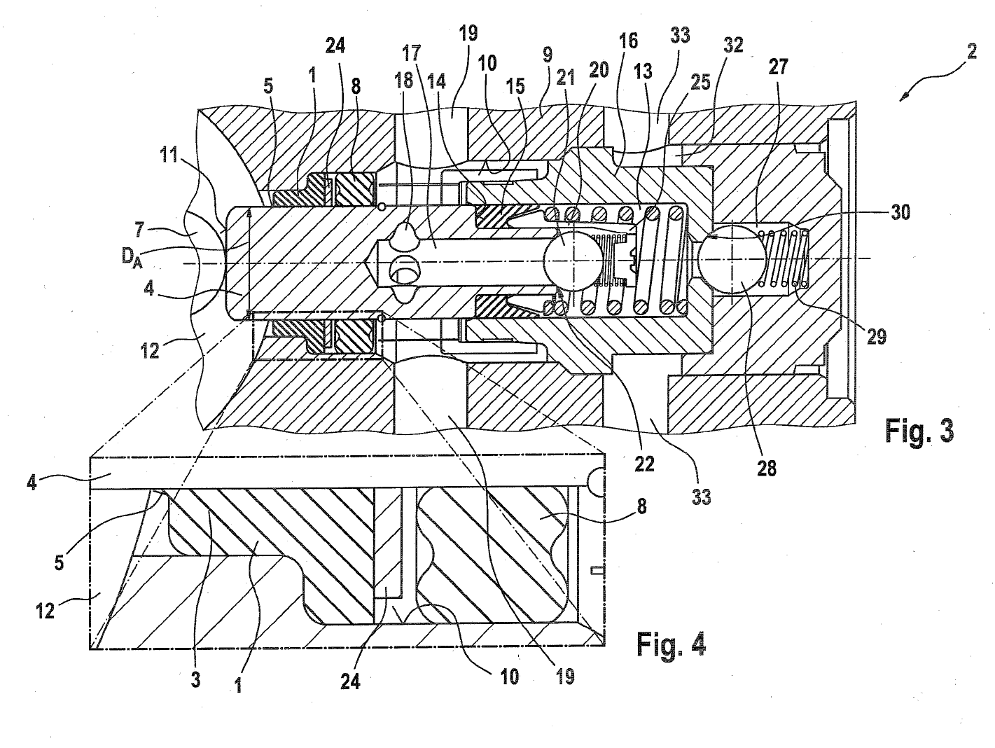

In FIGS. 1 and 2, one possible embodiment of a guide ring 1 for a piston pump 2 shown in FIGS. 3 and 4 is shown.

The guide ring has a longitudinally graduated guide portion, whose inner diameter D_{F} is equivalent to the outer diameter D_{A} of an axially reciprocatable pump piston 4, shown in FIG. 3, of the piston pump 2, plus a minimal guidance play. An encompassing lip 5 extending all the way around axially adjoins the guide portion 3 and, beginning at the guide portion 3, extends in the axial direction as well as inward in the radial direction. A minimal inner diameter D_{I} of the lip 5 in the region of its free end edge 6 is dimensioned as smaller, in the uninstalled state shown, than the outer diameter D_{A} of the pump piston 4 (see FIGS. 3 and 4). This assures that the lip 5, at least in the region of its end edge 6, rests durably on the pump piston 4, surrounding the pump piston.

As can be seen from FIG. 2, the inner diameter of the lip 5 decreases continuously in the axial direction, beginning at the inner diameter D_{F} of the guide portion 3 to the inner diameter D_{I}, shown in FIG. 2, in the region of the end edge 6 extending all the way around.

Since the guide ring 1 is embodied of a high-strength thermoplastic material, the guide ring 1 is rigid and incompressible in the region of the guide portion 3. By the weakening of material in the end region, or in other words by the provision of the lip 5, the guide ring 1 gains a damping property (action) in the region of the lip 5 for radial deflection motions of the pump piston 4. In other words, the guide ring 1, because of the provision of the radially resilient lip 5, serves as a damping element for radial impacts of the pump piston 4 that can be ascribed to radial force components which originate in the rotary motion of the eccentric 7 shown in FIG. 3.

Not shown is an embodiment in which in addition to the first lip 5, a second lip is provided, which is integrally formed onto the axial end of the guide portion 3 facing the first lip 5. The second lip, not shown, is preferably embodied mirror-symmetrically to the first lip 5 and prevents a ring seal 8, shown in FIG. 3, from being drawn into a region radially between the guide portion 3 of the guide ring 1 and the pump piston 4.

In FIGS. 3 and 4, the installed situation of the guide ring 1 in a piston pump 2 is shown. The piston pump is disposed in a hydraulic vehicle brake system 9, in which besides the piston pump 2, other components, not shown, of a hydraulic vehicle brake system with traction control, such as solenoid valves, check valves, and hydraulic reservoirs, are accommodated and interconnected hydraulically with one another. The hydraulic vehicle brake system 9 forms a pump housing of the piston pump 2. A multiply graduated pump bore 10 is disposed in this hydraulic vehicle brake system 9.

The pump piston 4 of the piston pump 2 protrudes, with its left face end 11 in terms of the plane of the drawing, into an eccentric chamber 12, in which the eccentric 7 is driven rotatably about an axis of rotation disposed perpendicular to the longitudinal direction of the pump piston 4. The eccentric 7 rests with its outer circumference on the face end 11 of the pump piston 4 and urges it in the axial direction with an adjusting force. The radial force component exerted by the eccentric 7 on the pump piston 4, which component seeks to deflect the pump piston 4 in the radial direction, is absorbed or intercepted at least in part and preferably completely by the lip 5 of the guide ring 1.

On the face end 14 oriented away from the eccentric chamber 12 and toward a positive displacement chamber 13, there is a plastic sealing element 15, which seals off the positive displacement chamber (high-pressure side) from an intake side (low-pressure side) of the piston pump 2. To that end, the sealing element 15 is disposed radially between the pump piston 4 and a bush 16. The bush 16 is fixed with a press fit in the pump bore 10.

For the pump inlet, an axially extending blind bore 17 on the face end is made in the pump piston 4 and is intersected near its bottom by transverse bores 18. The blind bore 17 and the transverse bores 18 communicate with inflow bores 19 in the hydraulic vehicle brake system 9.

On the end of the pump piston 4 toward the positive displacement chamber, a check valve is provided as an inlet valve 20. The inlet valve 20 has a valve ball 21, which cooperates with a conical inlet valve seat 22 on the pump piston 4. A closing spring 23, which is braced in the axial direction on one end on the plastic housing 25 of the inlet valve 20 and on the other end on the valve ball 21, urges the valve ball 21 in the closing direction onto the inlet valve seat 22. The plastic housing 25 of the inlet valve 20 is subjected to spring force in the axial direction, counter to the sealing element 15, by a restoring spring for the pump piston 4. The restoring spring 26 is received in the positive displacement chamber 13.

An outlet valve 27, also embodied as a check valve, with a valve ball 28 is also disposed on the end of the positive displacement chamber 13 and is urged by spring force by a closing spring 29 onto a hollow-conical valve seat 30 on the bush 16. The closing spring 29 is braced axially on a closure cap of the piston pump 2. When the outlet valve is open, hydraulic fluid (brake fluid) can flow out of the positive displacement chamber, via a radial conduit, not shown, into an annular chamber 32 radially outside the bush 16, and from there outward into outflow conduits 33.

In the enlarged view in FIG. 4, the precise installed position of the guide ring 1 can be seen. The guide ring 1 is disposed with a press fit in the graduated pump bore 10, and the radially resilient lip 5 extending all the way around is oriented in the direction of the eccentric chamber 12. The lip 5 damps radial adjusting motions of the pump piston 4, and the lip rests radially outward, directly over the full circumference, on the pump piston 4. Between the guide portion 3 of the guide ring 1 and the pump piston 4, conversely, a minimal guidance play is provided. Axially between the guide ring 1 and the ring seal 8, a support ring 24 is provided, which is seated firmly on the pump piston 4. It prevents a penetration of the ring seal 8 into the guide gap between the guide portion 3 and the pump piston 4. If in addition to the first lip 5, a second lip pointing in the direction of the ring seal 8 is provided, then a support ring 24 of this kind may optionally be dispensed with.

1-12. (canceled)

13. A guide ring for an axially reciprocating pump piston or for a piston rod of a piston pump, which guide ring is embodied as a radial damping element which damps radial impacts of the pump piston or the piston rod.

14. The guide ring as defined by claim 13, wherein the guide ring has a first radially resilient lip extending around an entire circumference of the guide ring.

15. The guide ring as defined by claim 13, wherein an inner diameter of the first lip in an uninstalled state is less than an outer diameter of the pump piston or the piston rod.

16. The guide ring as defined by claim 14, wherein an inner diameter of the first lip in an uninstalled state is less than an outer diameter of the pump piston or the piston rod.

17. The guide ring as defined by claim 14, wherein the guide ring has a second radially resilient lip extending around the entire circumference of the guide ring.

18. The guide ring as defined by claim 16, wherein the guide ring has a second radially resilient lip extending around the entire circumference of the guide ring.

19. The guide ring as defined by claim 17, wherein the first lip and the second lip are disposed with their free end edges pointing in opposed axial directions.

20. The guide ring as defined by claim 18, wherein the first lip and the second lip are disposed with their free end edges pointing in opposed axial directions.

21. The guide ring as defined by claim 17, wherein the inner diameter of the first lip in the uninstalled state is less than the outer diameter of the pump piston or the piston rod.

22. The guide ring as defined by claim 18, wherein the inner diameter of the first lip in the uninstalled state is less than the outer diameter of the pump piston or the piston rod.

23. The guide ring as defined by claim 19, wherein the inner diameter of the first lip in the uninstalled state is less than the outer diameter of the pump piston or the piston rod.

24. The guide ring as defined by claim 20, wherein the inner diameter of the first lip in the uninstalled state is less than the outer diameter of the pump piston or the piston rod.

25. The guide ring as defined by claim 13, wherein the guide ring is embodied of a thermoplastic material, in particular of high strength.

26. A piston pump for a hydraulic vehicle brake system, having a pump piston or a piston rod that can be driven to an axial reciprocating motion, in which the pump piston or the piston rod is disposed as penetrating at least one guide ring, wherein the guide ring is embodied as defined by claim 13.

27. The piston pump as defined by claim 26, wherein the guide ring is disposed axially between an eccentric chamber and a ring seal.

28. The piston pump as defined by claim 26, wherein a first, radially resilient lip of the guide ring is disposed with its free end edge pointing toward the eccentric chamber.

29. The piston pump as defined by claim 27, wherein a first, radially resilient lip of the guide ring is disposed with its free end edge pointing toward the eccentric chamber.

30. The piston pump as defined by claim 27, wherein at least one second, radially resilient lip of the guide ring is disposed immediately adjacent to the ring seal.

31. The piston pump as defined by claim 28, wherein at least one second, radially resilient lip of the guide ring is disposed immediately adjacent to the ring seal.

32. The use of a guide ring as defined by claim 13 for damping a radial deflection motion of a pump piston or a piston rod in a piston pump for a vehicle brake system.
